(19) United States
(12) Patent Application Publication
(10) Pub. No.: US 2017/0261069 A1
(43) Pub. Date: Sep. 14, 2017

(54) GEARBOX WITH LIMIT MECHANISM

(71) Applicant: GREENSHPON ENGINEERING WORKS LTD., Misgav (IL)

(72) Inventor: Shimon SEADIA, Hatzor Haglilit (IL)

(21) Appl. No.: 15/065,922

(22) Filed: Mar. 10, 2016

(51) Int. Cl. F16H 1/20; F16H 63/50; F16H 49/00

(52) U.S. Cl. CPC F16H 1/203; F16H 49/001; F16H 63/50

(57) ABSTRACT

A gearbox that is configured to transmit torque from a motor shaft to a load shaft includes a limit mechanism The limit mechanism includes a strain wave gear including a circular spline, a flex spline and a wave generator. The circular spline is fixed to a housing of the gearbox coaxially with the load shaft, the flex spline is formed on a flexible rim of a rotatable cup that is coaxial with the load shaft, and the wave generator is coupled to the load shaft so as to rotate at the same angular velocity. The limit mechanism further includes at least one limiter structure coupled to the rotatable cup and at least one fixed switch, and is configured to stop rotation of the load shaft when the limiter structure engages the fixed switch.

### FIELD OF THE INVENTION

The present invention relates to gearboxes. More particularly, the present invention relates to a gearbox with a limit mechanism.

### BACKGROUND OF THE INVENTION

Gearboxes may be utilized when a motion of one type by a motor is to be transformed to another type of motion of a load. For example, the transformation may include a change in direction of motion, type of motion (e.g., circular or linear), speed of motion, or any combination of the above. The gearbox may include one or more types of gears, each gear being characterized by a gear ratio. A gear ratio may be selected in accordance with the power output of the motor and the force that is to be applied to the load.

For example, in some cases a gear box may enable a motor to raise or lower a roller shutter or roller door. In some cases, accuracy of the operation may be critical. For example, in some agricultural applications, a roller shutter of a ventilation door or window, e.g., of a poultry house, greenhouse, or other agricultural facility, may open or close in response to sensed conditions. The amount of opening and closing may require precise control in order to ensure the wellbeing of the poultry or produce being raised.

### SUMMARY OF THE INVENTION

There is thus provided, in accordance with an embodiment of the present invention, a gearbox configured to transmit torque from a motor shaft to a load shaft, the gearbox including a limit mechanism that includes a strain wave gear including a circular spline, a flex spline and a wave generator, wherein the circular spline is fixed to a housing of the gearbox coaxially with the load shaft, wherein the flex spline formed on a flexible rim of a rotatable cup that is coaxial with the load shaft, and wherein the wave generator is coupled to the load shaft so as to rotate at the same angular velocity, the limit mechanism further including at least one limiter structure coupled to the rotatable cup and at least one fixed switch, configured to stop rotation of the load shaft when one of the at least one limiter structure engages one of the at least one fixed switch.

Furthermore, in accordance with an embodiment of the present invention, the at least one fixed switch is fixed to the housing.

Furthermore, in accordance with an embodiment of the present invention, the at least one fixed switch includes two switches, and wherein the at least one limiter structure includes two limiter structures.

Furthermore, in accordance with an embodiment of the present invention, one of the two limiter structures is configured to engage one of the two switches when the load shaft is rotated in one direction and the other of the two limiter structures is configured to engage the other of the two switches when the load shaft is rotated in an opposite direction.

Furthermore, in accordance with an embodiment of the present invention, the circular spline includes more gear teeth than the flex spline.

Furthermore, in accordance with an embodiment of the present invention, the circular spline includes 2 or 4 more gear teeth than the flex spline.

Furthermore, in accordance with an embodiment of the present invention, the circular spline includes 66 gear teeth.

Furthermore, in accordance with an embodiment of the present invention, the gearbox includes a gear assembly for transmitting the torque from the motor shaft to the load shaft.

Furthermore, in accordance with an embodiment of the present invention, the gear assembly includes a worm gear.

Furthermore, in accordance with an embodiment of the present invention, the gear assembly is replaceable.

Furthermore, in accordance with an embodiment of the present invention, the at least one at least one limiter structure includes a tab.

Furthermore, in accordance with an embodiment of the present invention, the at least one fixed switch includes a mechanical switch that is depressible by the tab when the tab engages the mechanical switch.

Furthermore, in accordance with an embodiment of the present invention, the tab is mounted on a limiter ring that is rotatable relative to the cup to adjust a position of the tab.

Furthermore, in accordance with an embodiment of the present invention, the gearbox includes a plate that is configured to be tightened on the limiter ring to lock an orientation of the limiter ring relative to the cup.

Furthermore, in accordance with an embodiment of the present invention, the limit mechanism is configured to interrupt supply of electrical power to a motor that is coupled to the motor shaft when the at least one limiter structure engages the at least one fixed switch.

Furthermore, in accordance with an embodiment of the present invention, the wave generator includes two opposite arms.

Furthermore, in accordance with an embodiment of the present invention, the circular spline is fixed to the housing by a base that is fixable to and removable from the housing.

There is further provided, in accordance with an embodiment of the present invention, a method of operation of a gearbox, the method including operating a motor that is coupled to a motor shaft of the gearbox to cause a load shaft of the gearbox to rotate, the rotation of the load shaft causing rotation of at least one limiter structure that is coupled to a rotatable cup that is coaxial with the load shaft, a rim of the cup forming a flex spline of a strain wave gear whose circular spline is fixed to a housing of the gearbox coaxially with the load shaft and whose wave generator is coupled to the load shaft so as to rotate at the same angular velocity, the rotation of the load shaft continuing until one of the at least one limiter structure engages one of the at least one fixed switch.

Furthermore, in accordance with an embodiment of the present invention, engaging of the one of the at least one fixed switch interrupts supply of electrical power to the motor.

Furthermore, in accordance with an embodiment of the present invention, rotation of the load shaft operates a roller shutter.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 shows a gearbox with a limit mechanism, in accordance with an embodiment of the present invention.

FIG. 2A shows interior components of the gearbox shown in FIG. 1.

FIG. 2B shows another view of the interior components shown in FIG. 2A.

FIG. 2C is an exploded view of components of the gearbox shown in FIG. 1.

FIG. 3 shows an exploded view of components of a limit mechanism of the gearbox shown in FIG. 2C.

FIG. 4 shows a distortable cup of the limit mechanism shown in FIG. 3.

FIG. 5 shows an extender rotor of the limit mechanism shown in FIG. 3.

FIG. 6 shows a circular gear ring of the limit mechanism shown in FIG. 3.

FIG. 7 shows a support base of the circular gear ring shown in FIG. 6.

FIG. 8 is a flowchart schematically depicting an example of a method of operation of a gearbox with a limit mechanism, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non- transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

In accordance with an embodiment of the present invention, a gearbox is configured to transmit torque from a motor shaft to a load shaft so as to rotate the load shaft. For example, a motor may be coupled to the motor shaft. Operation of the motor may then rotate the motor shaft so as to rotate the load shaft at a relative rate that is determined by a gear ratio of a gear assembly of the gear box.

A limit mechanism is configured to stop rotation of the load shaft after a predetermined rotation (e.g., as measured by a total rotation angle) of the load shaft. The limit mechanism employs a strain wave gear mechanism to rotate a limiter structure until the rotatable limiter structure engages a corresponding fixed switch. The engaging of the rotatable limiter structure with the fixed switch may stop rotation of the load shaft. For example, the interaction of the rotatable limiter structure (e.g., in the form of a tab, or another structure) with the fixed switch (e.g., in the form of a mechanical or other switch) may stop rotation of the load shaft by interrupting an electrical power supply to the motor, or by otherwise interrupting the transmission of torque from the motor to the load shaft.

The strain wave gear mechanism includes a rigid circular ring with a first number of interior (inward facing) gear teeth. The circular ring is fixed to a housing of the gearbox coaxially with the load shaft. A rotatable cup is mounted coaxially with the load shaft. However, the cup is not coupled to the load shaft such that the cup may rotate at a rate or through a rotation distance that is different from that of the load shaft. (As used herein, two rotatable components are described as coupled when the two components are constrained to rotate at the same rate, or, equivalently, through the same rotation distance as one another.) At least a rim of the cup is flexible. An exterior side of the rim is surrounded by a second number of exterior gear teeth. The second number of exterior gear teeth is different than (e.g., less than) the first number of interior gear teeth. The exterior gear teeth are mounted interior to (proximal to) and substantially coplanar with the interior gear teeth on the fixed ring.

A rotatable limiter structure is mounted to an end of the cup. The rotatable limiter structure is rotatable together with, and at the same rotation rate as, the cup. The rotatable limiter structure is configured to engage a limiter device in the form of one or more fixed switches. For example, the switches may be fixed to the housing or to another fixed structure. The engagement of the switches by the rotatable limiter structure is configured to stop rotation of the load shaft (e.g., by interrupting the supply of electric power or fuel to the motor, or by interrupting transmission of torque from the motor to the load shaft).

A rotor is coupled to the load shaft. The rotor includes one or more (e.g., two) arms that extend laterally (used herein to refer to extension in a plane that is substantially perpendicular to the axis of rotation of the rotor) within the cup. Each arm is configured such that a distal end of the arm pushes outward against a section of the rim of the cup. When the section of the rim is pushed outward by the arm, the exterior gear teeth on that section are extended outward to engage the interior gear teeth on the fixed circular ring.

Rotation of the load shaft causes the distal end of the arm to sequentially (in time) extend successive (along the perimeter of the rim) exterior gear teeth on the rim of the cup to engage the interior gear teeth. As a result of the sequential engaging of the fixed interior gear teeth by successive exterior gear teeth, the cup is rotated. The rotation angle of the cup is determined by the rotation angle of the load shaft and by the first number and the second number. Equivalently, a rate or distance of rotation of the cup relative to the rotation of the load shaft is determined by the first number of fixed interior gear teeth, and by the second number of rotatable and extendible exterior gear teeth.

The resulting gearbox limit mechanism is configured to limit rotation of the load shaft. For example, limiting rotation of the load shaft may prevent movement of the load beyond a predetermined range.

An arrangement of gears in the gearbox is configured to transmit the torque from the motor shaft to the load shaft. For example, the gear arrangement may include one or more worm gears. One or more components of the gear arrangement may be modular or otherwise replaceable or modifiable so as to adapt a gear ratio of the gear arrangement to a particular application. Typically, the load shaft is substantially perpendicular to the motor shaft. Other arrangements may be possible (e.g., with the load shaft substantially parallel to the motor shaft, or at an oblique angle to the motor shaft.

The load shaft may be connected to a load. The load shaft may be connected to an axle, belt drive, pulley, reel, or other mechanism for raising, lowering, or otherwise moving a load. For example, the load shaft may be connected to a belt drive or axle for raising or lowering a roller shutter or roller door.

Operation of the limit mechanism may be described as a strain wave gear mechanism. A distortable cup of the strain wave gear mechanism has a circular cross section when undistorted. The distortable cup is mounted coaxially with (but not coupled to) the load shaft and is configured to rotate about its axis in response to a tangential force.

At least a part of the cup near its rim is constructed of a flexible and elastic material. The exterior perimeter of the rim is lined with outward facing exterior gear teeth to function as a flex spline of the strain wave gear mechanism.

An extender rotor is coupled to the load shaft to function as a wave generator of the strain wave gear mechanism One or more arms (e.g., two) extend laterally (e.g., substantially radially) outward from an axis of the extender rotor. The length of each arm (from the axis to the distal end of the arm) is longer than the internal diameter of undistorted circular cross section of the distortable cup. Therefore, when the extender rotor rotates within the rim of the distortable cup, the arms of the distortable cup sequentially extend outward successive exterior gear teeth.

The exterior gear teeth along the perimeter of the rim are surrounded by a fixed (e.g., to a housing of the gearbox) circular ring of inward facing interior gear teeth to function as a circular spline of the strain wave gear mechanism The number of interior gear teeth on the ring is different (e.g., larger, e.g., two or four more, or another number) than the number of exterior gear teeth on the rim of the distortable cup.

The inner diameter of the interior gear teeth of the fixed ring is somewhat larger than the outer diameter of the exterior gear teeth on the rim of the distortable cup when the cup is undistorted. Rotation of the extender rotor within the distortable cup successive extends the exterior gear teeth sufficiently outward so as to engage the interior teeth of the fixed ring. As a result, the distortable cup is caused to rotate. When the number of interior teeth is greater than the number of exterior gear teeth, the rotation of the cup is in a direction that is opposite the rotation of the load shaft. The rate or distance of rotation by the cup relative to the rate or distance, respectively, of the rotation of the coupled load shaft and extender rotor, may be referred to as the reduction ratio. The reduction ratio is determined by the (first) number of interior gear teeth on the fixed ring (circular spline) and by the (second) number of exterior gear teeth on the rim (flex spline) of the distortable cup. When the extender rotor has two opposite arms (separated by 180°, the reduction ratio is equal to the difference between the (second) number of exterior gear teeth on the rim and the (first) number of interior gear teeth on the fixed ring, divided by the number of (second) exterior gear teeth on the rim, or:

reduction ratio=(flex spline teeth−circular spline teeth)/flex spline teeth

=(second number−first number)/second number.

A negative reduction ratio denotes rotation of the flex spine (the distortable cup) in a direction that is opposite the direction of rotation of the wave generator (of the extender rotor and the coupled load shaft). For example, if the fixed ring has 66 interior gear teeth and the rim of the distortable cup has 64 exterior gear teeth, the reduction ratio is −1/32 (−0.03125). Thus, in this example, the distortable cup may rotate one complete reverse rotation for every 32 rotations of the load shaft. Similarly, if the fixed ring has 66 interior gear teeth and the rim of the distortable cup has 62 exterior gear teeth, the ratio of the rate of rotation of the load shaft to the rate of backward rotation of the distortable cup may be −1/16 (−0.0625). Thus, in this example, the distortable cup may rotate one complete reverse rotation for every 16 rotations of the load shaft.

One or more rotatable limiter structures may be attached to or mounted on the distortable cup. For example, the rotatable limiter structures may include one or more arms or tabs that extend laterally outward from, and are rotatable with, the distortable cup. Alternatively, or in addition, the rotatable limiter structure may include one or more optical elements (e.g., light source, light detector, reflector, beam interrupter, or other optical element), electromagnetic elements (e.g., proximity sensor) or other elements that may interact with electronics to limit motion. The rotation rate of the distortable cup may be adjusted such that each rotatable limiter structure rotates by less than a full rotation during the full travel of the load shaft. For example, if the load shaft must be rotated by predetermined number or rotations in order to fully raise or lower a roller shutter, the rotation rate of the distortable cup may be such that the rotatable limiter structure is rotated through an angle of less than 360° during the full raising or lowering.

The limit mechanism includes a fixed switch that may be engaged by the rotatable limiter structure to limit rotation of the load shaft. For example, the fixed switch may include a contact switch or mechanical limit switch that may be pressed or moved by a rotatable limiter structure in the form of an arm or tab that is rotated to the switch. Operation of the switch may interrupt electrical power to the motor that is coupled to the motor shaft. Thus, motion of the lead shaft and the load may be stopped at a predetermined position. Other types of switches or rotatable limiter structures may be used.

The rotatable limiter structure may be rotated or otherwise moved long the distortable cup in order to set a stop position. Typically, two rotatable limiter structures may be provided in order to set a stopping point for motion of the load in both rotation directions (e.g., while opening a roller shutter and while closing the roller shutter). The distortable cup may include gradations or other markings to assist in setting the rotatable limiter structures to a desired position. A locking structure may be provided in order to prevent accidental or unintentional movement of the rotatable limiter structure.

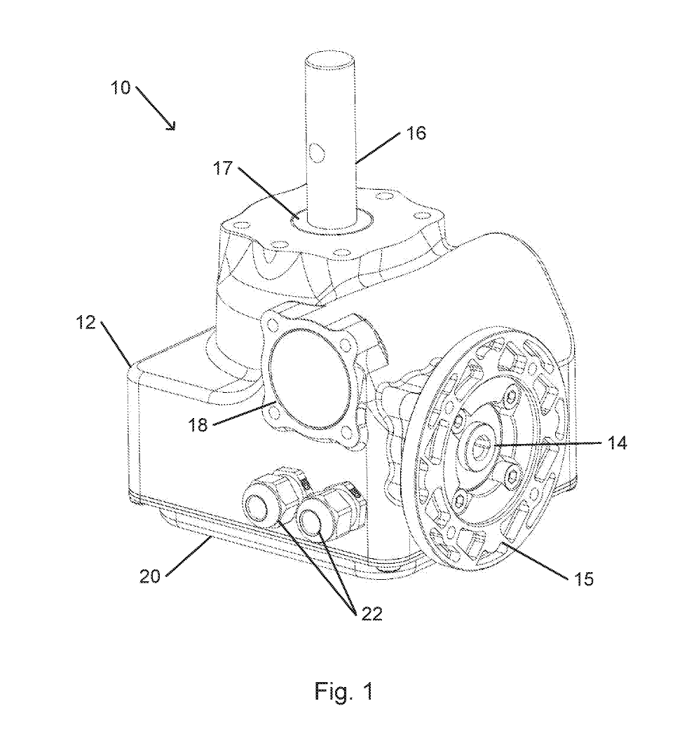

FIG. 1 shows a gearbox with a limit mechanism, in accordance with an embodiment of the present invention.

Components of gearbox 10 are enclosed in gearbox housing 12. A motor may be coupled to motor shaft 14. For example, structure of the motor may be coupled (e.g., bolted or otherwise coupled) to coupling structure 15. Coupling structure 15 may include a flange as shown, or a socket, drive fitting, non-circular projection, or other suitable coupling structure. Operation of the motor that is coupled to motor shaft 14 may apply a torque to motor shaft 14. Coupling structure 15 may include shaft coupler structure 13. Shaft coupler structure 13 may include one or more sleeves, bearings, oil seals, or other structure configured to hold motor shaft 14 in place and to enable rotation of motor shaft 14.

Torque that is applied to motor shaft 14 may be transmitted to load shaft 16 to rotate load shaft 16. Load shaft 16 may be coupled to a load that is to be moved by load shaft 16. For example, load shaft 16 may be coupled to an axle, gear, cam, pinion, pulley, wheel, or other structure that is connected to an object that is to be moved in one or more directions. Load shaft support structure 17 may include one or more sleeves, bearings, oil seals, or other structure configured to hold load shaft 16 in place and to enable rotation of load shaft 16.

Torque may be transmitted from motor shaft 14 to load shaft 16 via gear assembly 18. Gear assembly 18 includes one or more gears (e.g., cogwheels, worms, or other gear structure). The gears of gear assembly 18 are configured to engage corresponding gears that are fixed to motor shaft 14 and to load shaft 16. Gear assembly 18 may be removable from gearbox 10. For example, gear assembly 18 may be removed from gearbox 10 for servicing or for replacement with another gear assembly 18, e.g., providing a different gear ratio (e.g., together with replacing any cooperating structure, e.g., worm 24 of motor shaft 14, worm gear 29, or other cooperating structure). Thus, gearbox 10 may be adapted to different applications requiring different gear ratios.

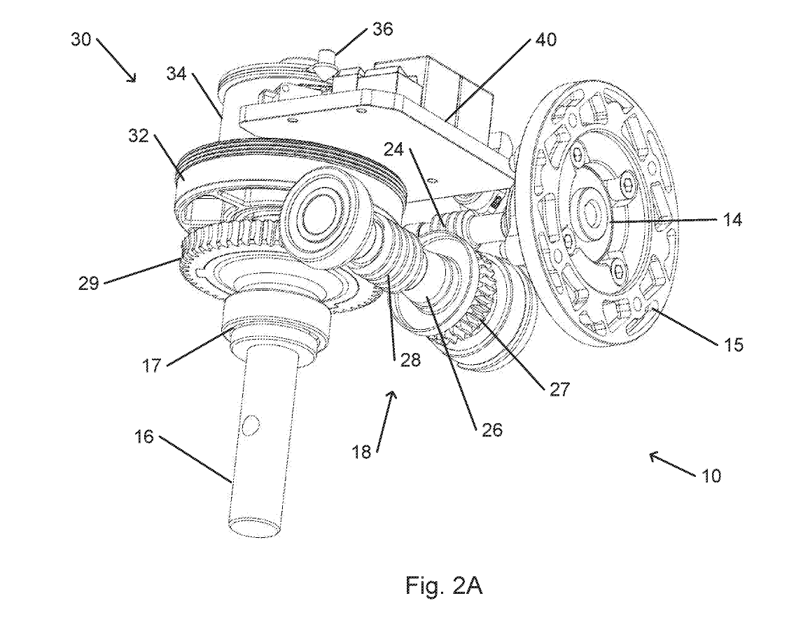

Gearbox 10 includes a limit mechanism 30 (FIG. 2A). Some components of limit mechanism 30 are coupled to load shaft 16 so as to rotate together with load shaft 16. Limiting structure of limit mechanism 30 may be adjusted for a particular application (e.g., to stop operation of the motor when an object, such as a roller shutter, is fully lifted or lowered). Components of limit mechanism 30 may be accessible for adjustment, maintenance, or otherwise by opening or removing limit mechanism cover 20.

Electrical connections to components of gearbox 10 may be made via electrical cable ports 22. For example, an electrical power cable for a motor that is coupled to motor shaft 14 may be connected to a power supply (e.g., mains or generator) via circuitry that is enclosed within gearbox 10. The circuitry and connections may be configured such that the electrical power supply to the motor may be interrupted by operation of limit mechanism 30.

FIG. 2A shows interior components of the gearbox shown in FIG. 1. FIG. 2B shows another view of the interior components shown in FIG. 2A. FIG. 2C is an exploded view of components of the gearbox shown in FIG. 1.

For example, motor shaft 14 may include worm 24 that rotates together with motor shaft 14. Worm 24 may engage worm gear 27 on gear assembly shaft 26 of gear assembly 18. Thus rotation of motor shaft 14 may rotate gear assembly shaft 26 at a speed that may be determined, at least in part, by the pitch of worm 24 and by the diameter of and number of gear teeth on worm gear 27. Gear assembly shaft 26 includes worm 28 that rotates together with gear assembly shaft 26. Worm 28 is configured to engage worm gear 29 on load shaft 16. Thus, rotation of gear assembly shaft 26 may rotate load shaft 16 at a rate that is determined, at least in part, by the pitch of worm 28 and by the diameter of and number of gear teeth on worm gear 29. Other arrangements of gears, or additional intervening gears, may be provided.

For example, in the example shown, a total gear ratio of gearbox 10 may be changed by replacing a gear assembly 18 that includes worm gear 27 with a first number of gear teeth, with a gear assembly 18 that includes a worm gear 27 having a second number of gear teeth. Cooperating structure may also be replaced. In some cases, this replacement may be performed on site.

Limit mechanism 30 may interact with components of circuitry 40 to limit operation of a motor that is coupled to motor shaft 14. Circuitry 40 may include one or more components that are mounted on one or more circuit boards. Some or all circuit boards on which circuitry 40 is mounted may be fixed to gearbox housing 12.

For example, the motor may be connected to one of connectors 48 to circuitry 40 (e.g., via an electrical cable port 22). Similarly, an external power source (e.g., power mains, generator, or other electrical power source) may be connected (e.g., via an electrical cable port 22) to other connectors 48 of circuitry 40. Power from the external power source may be connected to the motor via a relay 46. One or more user switches 44 may be operated by a user. User operation of a switch 44 may enable connection of the external power source (e.g., an on-off switch), initiation of operation of the motor in a forward or a reverse direction (e.g., by closing a relay 46), or other control of operation of the motor.

For example, rotation of load shaft 16 may operate limit mechanism 30 to rotate a rotatable limiter structure 36 in the form of a radially extended tab toward a limiter device that is fixed to gearbox housing 12. For example, the fixed limiter device may include a limit switch 42 that is fixed to circuitry 40 that is fixed, in turn, to gearbox housing 12. Limit switch 42 may include a mechanically operated depressible switch as shown. Alternatively or in addition, limit switch 42 may include an optically, electromagnetically, thermally, or otherwise operated switch. When rotatable limiter structure 36 contacts or otherwise engages limit switch 42, limit switch 42 may be depressed or otherwise operated. Operation of limit switch 42 may operate components of circuitry 40, e.g., open a relay 46, to interrupt the supply of electrical power to a motor that is coupled to motor shaft 14.

Alternatively or in addition, limit mechanism 30 may include other types of rotatable limiter structure. For example, rotatable limiter structure may include an optical component (e.g., light source, light detector, reflector, refracting element, beam interrupter element, or other optical component). Rotation of the optical component may interact with corresponding optical components of circuitry 40 to complete an optical beam connection, to interrupt an optical beam connection, or to otherwise affect transmission of an optical beam from a source to a detector. Completion or interruption of the optical beam connection may open relay 46 or otherwise interrupt the supply of electrical power to the motor. Alternatively, or in addition, limit mechanism 30 may include electromagnetic, acoustic, mechanical, or other types or limiting structure.

Limit mechanism 30 includes strain wave gear 31 that is configured to couple rotation of load shaft 16.

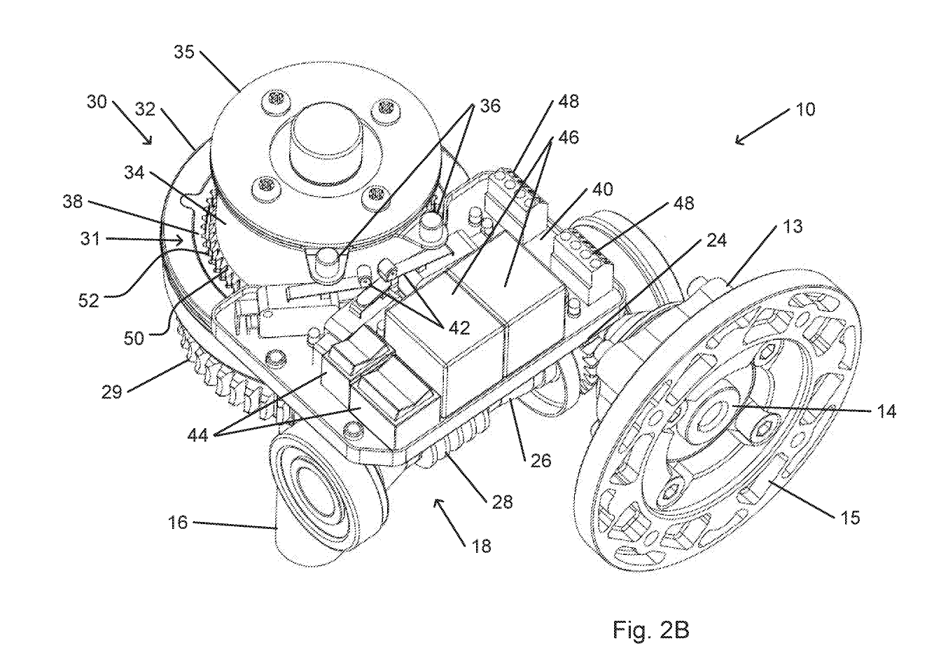

FIG. 3 shows an exploded view of components of a limit mechanism of the gearbox shown in FIG. 2C.

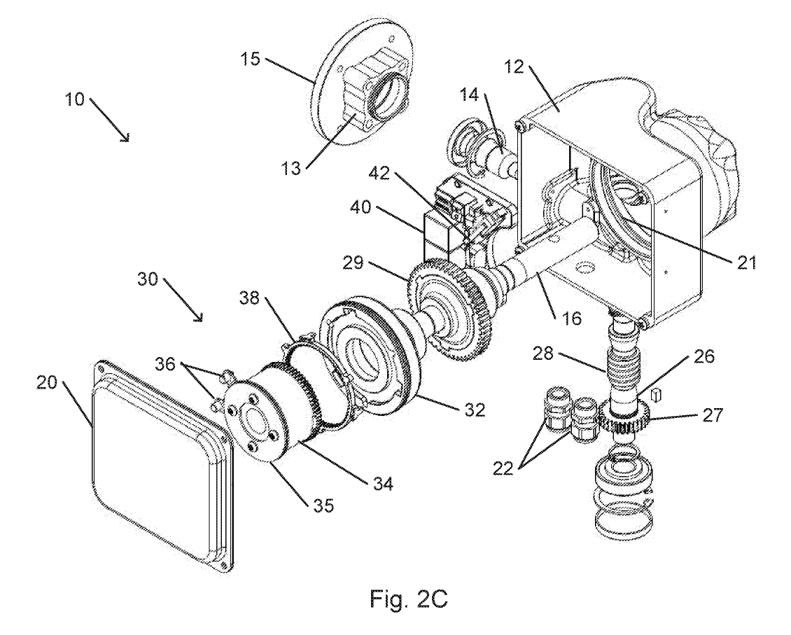

Rotatable limiter structure 36 of limit mechanism 30 is coupled to end 34c of distortable cup 34. At least rim 34b (FIG. 4) of distortable cup 34 may be made of a flexible (and, in some cases, resilient) plastic material (e.g., nylon 11, or another suitable material). End 34c of distortable cup 34 may be more rigid than (e.g., thicker or made of a more rigid material than) rime 34b. Distortable cup 34 (as well as other plastic components of limit mechanism 30 or of gearbox 10) may be produced by injection molding, compression molding, machining, or another suitable production method.

For example, rotatable limiter structure 36 may be attached to a limiter ring 37. A limit point (e.g., a rotation of load shaft 16) at which motion is to be stopped may be determined by adjusting an orientation of limiter ring 37 and its attached rotatable limiter structure 36. The orientation of limiter ring 37 may be adjusted by rotation of limiter ring 37 about an axis of distortable cup 34 relative to distortable cup 34. A position of limiter ring 37 may be locked in place in a particular orientation relative to distortable cup 34 by limiter locking plate 35. For example, limiter locking plate 35 may be tightened against limiter rings 37 and distortable cup 34 by threading screws into screw holes 35a and 34a. Limit mechanism 30 may be further protected from accidental, unintentional, or unauthorized tampering by closing limit mechanism cover 20 onto gearbox housing 12.

FIG. 4 shows a distortable cup of the limit mechanism shown in FIG. 3.

Distortable cup 34 is configured to rotate coaxially with, but at a different rotation rate than, load shaft 16. An outer perimeter of rim 34b of distortable cup 34 is provided with outward-facing exterior gear teeth 50. Rim 34b is distortable to function as a flex spline of strain wave gear 31 of limit mechanism 30.

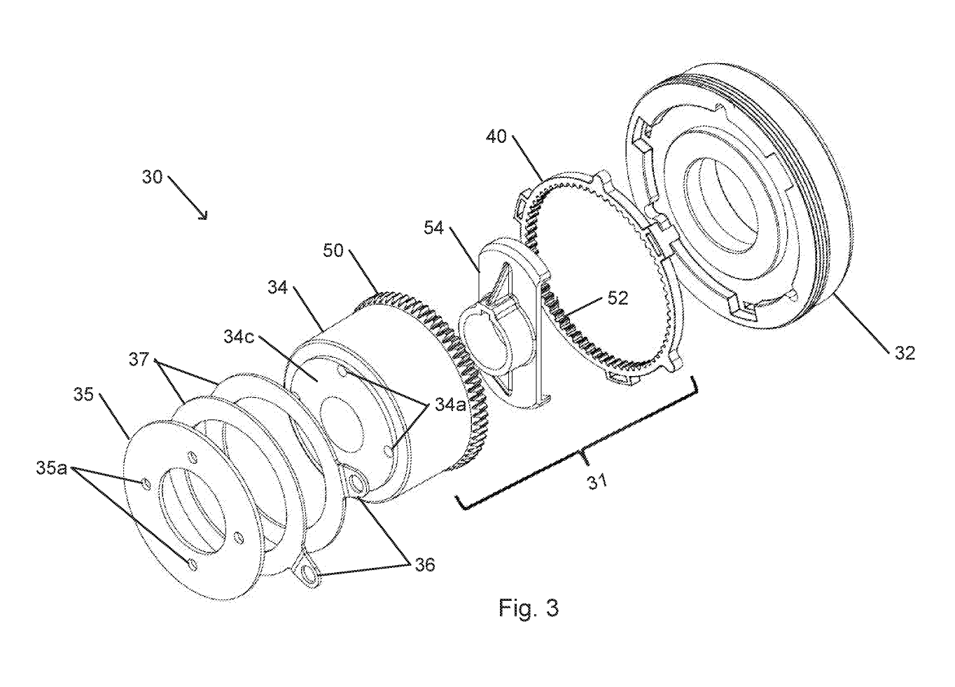

FIG. 5 shows an extender rotor of the limit mechanism shown in FIG. 3.

Extender rotor 54 is configured to be coupled to load shaft 16. Load shaft 16 may be inserted through central opening 63 in rotor sleeve 62 of extender rotor 54. Relative rotation between extender rotor 54 and load shaft 16 may be prevented by structure on load shaft 16 (e.g., a screw, tab, ridge, or other projection) that may be inserted into parallel keyway groove 64 (and whose width is substantially equal to that of parallel keyway groove 64) in the interior wall of rotor sleeve 62.

Extender rotor 54 includes one or more extender arms 60. Extender arms 60 may function as a wave generator of strain wave gear 31 of limit mechanism 30. Typically, the number of extender arms 60 is two, as shown. For example, two extender arms 60 may reduce backlash in limit mechanism 30 relative to a single extender arm. In some cases, the backlash with two extender arms 60 may be minimal or negligible. (In some cases, more than two extender arms may result in no rotation of distortable cup 34.)

Each extender arm 60 has a length (from the axis of rotation of extender rotor 54) that is sufficient to extend exterior gear teeth 50 outward so as to engage interior gear teeth 52 of circular gear ring 38 that surrounds rim 34b. For example, when extender arm 60 is substantially flat, extender arms 60, exterior gear teeth 50, and interior gear teeth 52 may be situated such that they are all substantially coplanar. A distal end of each extender arm 60 may be rounded to facilitate rotation within, and successive extension of, rim 34b.

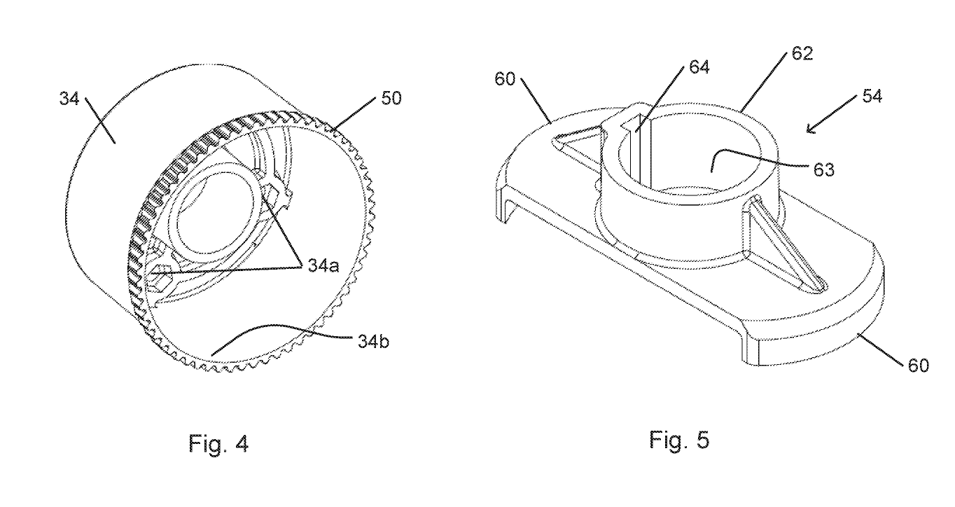

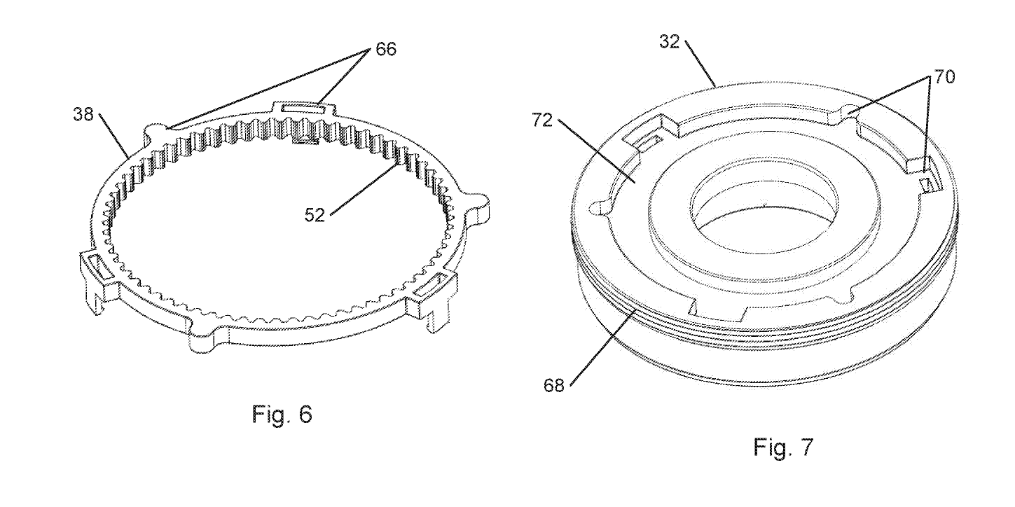

FIG. 6 shows a circular gear ring of the limit mechanism shown in FIG. 3. FIG. 7 shows a support base of the circular gear ring shown in FIG. 6.

An inner surface of circular gear ring 38 includes a plurality of inward-facing interior gear teeth 52. Exterior gear teeth 50 are situated within, and substantially coplanar with, interior gear teeth 52 (e.g., as seen in FIG. 2B). Interior gear teeth 52 are configured to be engaged by exterior gear teeth 50 on rim 34b of distortable cup 34 when extended by rotation of extender rotor 54. The (first) number of interior gear teeth 52 is different, e.g., larger, than the (second) number of exterior gear teeth 50. Thus, circular gear ring 38 may function as a circular spline of the strain wave gear 31 of limit mechanism 30.

Ring support base 32 may be fixed to gearbox housing 12. For example, base threading 68 may be screwed into threaded opening 21 of gearbox housing 12. Alternatively or in addition, ring support base 32 may be otherwise fixed (e.g., by screws, bolds, clips, latches, or otherwise) to gearbox housing 12.

Circular gear ring 38 may be held in place by ring support base 32. Circular gear ring 38 may be inserted into ring groove 72 of ring support base 32. Ring fixing structure 56 of circular gear ring 38 may engage ring gear holding structure 70 to hold circular gear ring 38 to ring support base 32. For example, one or both of ring fixing structure 56 and ring gear holding structure 70 may include one or more latches that are configured to engage one or more corresponding slots of the other.

Ring support base 32 may include ring gear holding structure 70 for fixing an orientation of circular gear ring 38 relative to ring support base 32. For example, circular gear ring 38 may include ring fixing structure 56 (e.g., including one or more each of one or more of tabs, projections, latches, slots, notches, grooves, or other structure) that is configured to engage ring gear holding structure 70 (e.g., including one or more each of one or more of corresponding tabs, projections, latches, slots, notches, grooves, or other structure). When ring fixing structure 56 engages ring gear holding structure 70, rotation of circular gear ring 38 relative to ring support base 32 may be prevented or limited.

Thus, circular gear ring 38 may be fixed via ring support base 32 to gearbox housing 12. When load shaft 16 is rotated by a motor that is coupled to motor shaft 14, extender rotor 54 rotates together with load shaft 16. Rotation of extender rotor 54 sequentially extends successive sections of exterior gear teeth 50 on distortable cup 34 to engage interior gear teeth 52 of circular gear ring 38. Since circular gear ring 38 is fixed to gearbox housing 12 and distortable cup 34 is free to rotate, distortable cup 34 is caused to rotate. The rate of rotation of distortable cup 34 relative to the rate of rotation of extender rotor 54, and thus of load shaft 16, is determined by the number of exterior gear teeth 50 and the number of interior gear teeth 52. (For example, when the number of interior gear teeth 52 is 66 and the number of exterior gear teeth 50 is 64, distortable cup 34 rotates through a rotation angle that is 1/32 of the rotation angle of load shaft 16.)

As distortable cup 34 rotates, a rotatable limiter structure 36 is rotated together with distortable cup 34. Eventually, rotation of distortable cup 34 brings rotatable limiter structure 36 to limit switch 42. Interaction of rotatable limiter structure 36 with limit switch 42 may interrupt power that is supplied to the motor, or otherwise prevent the motor from further rotating motor shaft 14.

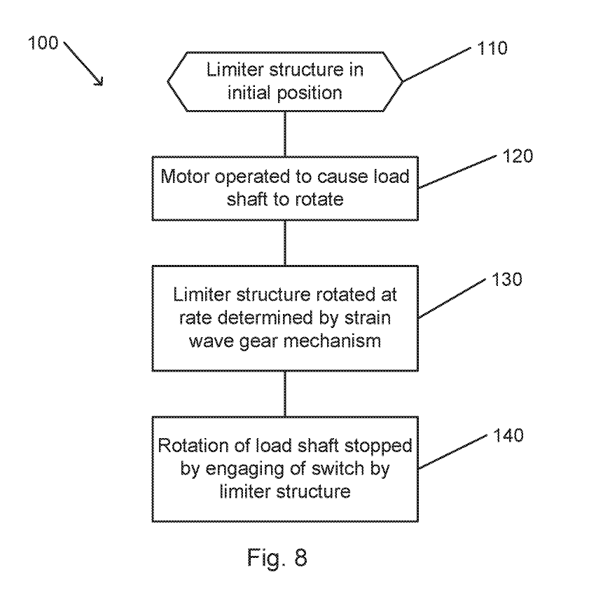

FIG. 8 is a flowchart schematically depicting an example of a method of operation of a gearbox with a limit mechanism, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Operation of gearbox operation method 100 may be performed by a gearbox 10 when rotatable limiter structure 36 is in an initial position (block 110). For example, a position of rotatable limiter structure 36 may have been changed or set by an operator. As another example, rotatable limiter structure 36 may have been moved to its current position during previous operation of gearbox 10.

A motor that is coupled to motor shaft 14 may operate to rotate motor shaft 14. The rotation of motor shaft 14 may be transmitted, via gear assembly 18 and with a gear ratio that is determined at least in part by a configuration of gear assembly 18, to cause load shaft 16 to rotate (block 120). For example, operation of the motor may be initiated by an operator of gearbox 10 by operating a switch 44. Alternatively or in addition, operation of the motor may be automatically initiated, e.g., by a timer or by a mechanism that responds to a sensed condition by a sensor (e.g., temperature sensor or thermostat, photonic sensor, humidity sensor, wind sensor, or another sensor of ambient conditions).

Load shaft 16 may be coupled to a load. For example, such a load may include a roller shutter, or another object that is to be lifted, lowered, or otherwise moved through a predetermined distance.

Rotation of load shaft 16 rotates extender rotor 54. Extender rotor 54 functions as a wage generator of strain wave gear 31 of limit mechanism 30 to rotate rotatable limiter structure 36. The degree of rotation of rotatable limiter structure 36 relative to the degree of rotation of load shaft 16 is determined by the number of gear teeth in the flex spline and circular spine of strain wave gear 31 (block 130).

After a predetermined rotation of rotatable limiter structure 36, corresponding to a predetermined rotation of load shaft 16, rotatable limiter structure 36 engages limit switch 42 to stop rotation of load shaft 16 (block 140). For example, engaging limit switch 42 may interrupt a supply of electrical power to the motor. The predetermined rotation may correspond to a predetermined travel distance of a load object. For example, the predetermined rotation may correspond to a position where a roller shutter is fully opened or completely shut.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A gearbox configured to transmit torque from a motor shaft to a load shaft, the gearbox comprising:
a limit mechanism that includes a strain wave gear including a circular spline, a flex spline and a wave generator, wherein the circular spline is fixed to a housing of the gearbox coaxially with the load shaft, wherein the flex spline is formed on a flexible rim of a rotatable cup that is coaxial with the load shaft, and wherein the wave generator is coupled to the load shaft so as to rotate at the same angular velocity,
the limit mechanism further including at least one limiter structure coupled to the rotatable cup and at least one fixed switch configured to stop rotation of the load shaft when one of said at least one limiter structure engages one of said at least one fixed switch.

2. The gearbox of claim 1, wherein said at least one fixed switch is fixed to the housing.

3. The gearbox of claim 1 wherein said at least one fixed switch comprises two switches, and wherein said at least one limiter structure comprises two limiter structures.

4. The gearbox of claim 3, wherein one of the two limiter structures is configured to engage one of the two switches when the load shaft is rotated in one direction and the other of the two limiter structures is configured to engage the other of the two switches when the load shaft is rotated in an opposite direction.

5. The gearbox of claim 1, wherein the circular spline includes more gear teeth than the flex spline.

6. The gearbox of claim 5, wherein the circular spline includes two or four more gear teeth than the flex spline.

7. The gearbox of claim 1, wherein the circular spline includes 66 gear teeth.

8. The gearbox of claim 1, further comprising a gear assembly for transmitting the torque from the motor shaft to the load shaft.

9. The gearbox of claim 8, wherein the gear assembly comprises a worm gear.

10. The gearbox of claim 8, wherein the gear assembly is replaceable.

11. The gearbox of claim 1, wherein said at least one at least one limiter structure comprises a tab.

12. The gearbox of claim 11, wherein said at least one fixed switch comprises a mechanical switch that is depressible by the tab when the tab engages the mechanical switch.

13. The gearbox of claim 11, wherein the tab is mounted on a limiter ring that is rotatable relative to the cup to adjust a position of the tab.

14. The gearbox of claim 13, comprising a plate that is configured to be tightened on the limiter ring to lock an orientation of the limiter ring relative to the cup.

15. The gearbox of claim 1, wherein the limit mechanism is configured to interrupt supply of electrical power to a motor that is coupled to the motor shaft when said at least one limiter structure engages said at least one fixed switch.

16. The gearbox of claim 1, wherein the wave generator comprises two opposite arms.

17. The gearbox of claim 1, wherein the circular spline is fixed to the housing by a base that is fixable to and removable from the housing.

18. A method of operation of a gearbox, the method comprising:
operating a motor that is coupled to a motor shaft of the gearbox to cause a load shaft of the gearbox to rotate, wherein the rotation of the load shaft causes rotation of at least one limiter structure that is coupled to a rotatable cup that is coaxial with the load shaft, a rim of the cup forming a flex spline of a strain wave gear whose circular spline is fixed to a housing of the gearbox coaxially with the load shaft and whose wave generator is coupled to the load shaft so as to rotate at the same angular velocity, said rotation of the load shaft continuing until one of said at least one limiter structure engages one of said at least one fixed switch.

19. The method of claim 18, wherein engaging of said one of said at least one fixed switch interrupts supply of electrical power to the motor.

20. The method of claim 18, wherein rotation of the load shaft operates a roller shutter.
